(19) United States
(12) Patent Application Publication
(10) Pub. No.: US 2015/0044662 A1
(43) Pub. Date: Feb. 12, 2015

(54) ACCELERATION SENSATION PRESENTATION DEVICE, ACCELERATION SENSATION PRESENTATION METHOD, AND ACCELERATION SENSATION PRESENTATION SYSTEM

(71) Applicant: Sony Corporation, Tokyo (JP)

(72) Inventors: Naofumi Goto, Kanagawa (JP); Satoru Higashino, Tokyo (JP); Akira Suzuki, Kanagawa (JP); Toshihiro Horigome, Kanagawa (JP)

(73) Assignee: Sony Corporation, Tokyo (JP)

(21) Appl. No.: 14/449,255

(22) Filed: Aug. 1, 2014

(30) Foreign Application Priority Data
Aug. 8, 2013 (JP) 2013-164737

(51) Int. Cl. G09B 9/00

(52) U.S. Cl. CPC G09B 9/00
USPC 434/365

(57) ABSTRACT

An acceleration sensation presentation device which is attached to a vicinity of head of a user, the device including one or a plurality of spindles; and a spindle driving unit which generates a force in a direction different from a predetermined direction by moving the spindle in the predetermined direction.

### CROSS REFERENCE TO RELATED APPLICATIONS

This application claims the benefit of Japanese Priority Patent Application JP 2013-164737 filed Aug. 8, 2013, the entire contents of which are incorporated herein by reference.

### BACKGROUND

The present disclosure relates to an acceleration sensation presentation device, an acceleration sensation presentation method, and an acceleration sensation presentation system.

A device which presents to a user an acceleration sensation by arbitrarily changing a center of gravity of a headgear-type device which is mounted on the head of the user has been suggested (refer to Japanese Unexamined Patent Application Publication No. 2010-26865).

### SUMMARY

It is possible to present to a user an acceleration sensation using the device which is described in Japanese Unexamined Patent Application Publication No. 2010-26865, however, it is desirable to present more diversified acceleration sensations with respect to the user.

It is desirable to provide an acceleration sensation presentation device, an acceleration sensation presentation method, and an acceleration sensation presentation system.

According to an embodiment of the present disclosure, there is provided an acceleration sensation presentation device which is attached to a vicinity of head of a user, the device including one or a plurality of spindles; and a spindle driving unit which generates a force in a direction different from a predetermined direction by moving the spindle in the predetermined direction.

According to another embodiment, there is provided an acceleration sensation presentation device which is attached to a vicinity of head of a user, the device including: a housing into which a first spindle driving unit and a second spindle driving unit are built; a first movable unit which moves in a first direction according to an operation of the first spindle driving unit; a second movable unit which moves in a second direction which is approximately orthogonal to the first direction according to an operation of the second spindle driving unit; an arm unit which moves in the first direction in conjunction with the operation of the first movable unit, and moves in the second direction in conjunction with the operation of the second movable unit; and a spindle which is attached to an end portion of the arm unit.

According to still another embodiment of the present disclosure, there is provided an acceleration sensation presentation device which is attached to a vicinity of head of a user, the device including: a spindle; a first rail unit for causing the spindle to slide in a first direction according to a control by a spindle driving unit; and a second rail unit for causing the spindle to slide in a second direction which is orthogonal to the first direction according to a control by the spindle driving unit.

According to still yet another embodiment of the present disclosure, there is provided an acceleration sensation presentation method which includes: movably supporting a spindle using a spindle support unit in a vicinity of head of a user; and generating a force in a direction different from a predetermined direction by moving the spindle in the predetermined direction according to a control by a spindle driving unit.

According to still yet another embodiment of the present disclosure, there is provided an acceleration sensation presentation system which includes a first acceleration sensation presentation device which is attached to a vicinity of one ear of a user, and a second acceleration sensation presentation device which is attached to a vicinity of the other ear of the user, in which the first acceleration sensation presentation device includes a first spindle; a first spindle support unit which movably supports the first spindle; and a first spindle driving unit which generates a force in a direction different from a predetermined direction by moving the first spindle in the predetermined direction, in which the second acceleration sensation presentation device includes a second spindle; a second spindle support unit which movably supports the second spindle; and a second spindle driving unit which generates a force in a direction different from the predetermined direction by moving the second spindle in the predetermined direction, in which the first spindle driving unit moves the first spindle in at least one of a front-back direction, a horizontal direction, and a vertical direction with respect to the user, and in which the second spindle driving unit moves the second spindle in at least one of the front-back direction, the horizontal direction, and the vertical direction with respect to the user.

According to at least one of the embodiments, it is possible to present various acceleration sensations to a user. In addition, effects which are described here are not necessarily limited, and may be any one of effects which are described in the present disclosure. In addition, contents of the present disclosure are not to be interpreted as being limited due to the exemplified effects.

### BRIEF DESCRIPTION OF THE DRAWINGS

FIGS. 1A and 1B are diagrams which describe an example in a direction which is defined based on a user.

FIG. 2 is a diagram which describes an example of a configuration of an acceleration sensation presentation device according to one embodiment.

FIG. 3 is a diagram which describes an example of a configuration of an acceleration sensation presentation device according to the embodiment.

FIG. 4 is a diagram which describes an example of an operation of an acceleration sensation presentation device according to the embodiment.

FIG. 5 is a diagram which describes an example of an operation of an acceleration sensation presentation device according to the embodiment.

FIG. 6 is a diagram which describes an example of an acceleration sensation which is presented to a user along with a movement of a spindle.

FIG. 7 is a diagram which describes another example of the acceleration sensation which is presented to the user along with the movement of the spindle.

FIG. 8 is a diagram which describes another example of the acceleration sensation which is presented to the user along with the movement of the spindle.

FIG. 9 is a diagram which describes another example of the acceleration sensation which is presented to the user along with the movement of the spindle.

FIG. 10 is a diagram which describes a use example of the acceleration sensation presentation device according to the embodiment.

FIG. 11 is a diagram which describes a use example of the acceleration sensation presentation device according to the embodiment.

FIG. 12 is a diagram which describes one example of a system in which the acceleration sensation presentation device according to the embodiment is used.

FIG. 13 is a diagram which describes an example of a configuration of an acceleration sensation presentation device in a modification example.

FIG. 14 is a diagram which describes an example of a configuration of the acceleration sensation presentation device in the modification example.

FIG. 15 is a diagram which describes an application example of the acceleration sensation presentation device in the modification example.

FIG. 16 is a diagram which illustrates a state in which a user who is wearing a head mounted display on the head is viewed from the front.

FIG. 17 is a diagram which illustrates a state in which the user who is wearing the head mounted display illustrated in FIG. 16 is viewed from the top.

FIG. 18 is a diagram which illustrates an internal configuration example of the head mounted display.

### DETAILED DESCRIPTION OF EMBODIMENTS

Hereinafter, embodiments of the present disclosure will be described with reference to drawings. In addition, descriptions will be made in the following order.
1. One Embodiment
2. Modification Example

An embodiment, or the like, which is described below is a preferable specific example of the present disclosure, and contents of the present disclosure are not limited to the embodiments, and the like.

### 1. One Embodiment

### Outline of Acceleration Sensation Presentation Device

An acceleration sensation presentation device according to the embodiment, or the like, of the present disclosure can present an acceleration sensation to a user simply by an acceleration sensation presentation device being mounted in the vicinity of head of a user, differently from a device in which a large scale and expensive stage is used, which is provided at a game center, an amusement center, or the like.

The acceleration sensation presentation device according to the embodiment, or the like, of the present disclosure is mounted in the vicinity of the head of a user, for example, in the vicinity of ears of the user. One or more spindles with predetermined weight which are movable are provided in the acceleration sensation presentation device. A centre of gravity of the spindle moves due to a generation of a force (reaction force) in a predetermined direction which is different from a movement direction of the spindle when a position of the spindle is moved. It is possible to provide an acceleration sensation for a user due to the reaction force (force in which reaction force generated due to movement of each spindle is composited when plurality of spindles are moved). The user can feel the acceleration sensation, and can experience a virtual reality.

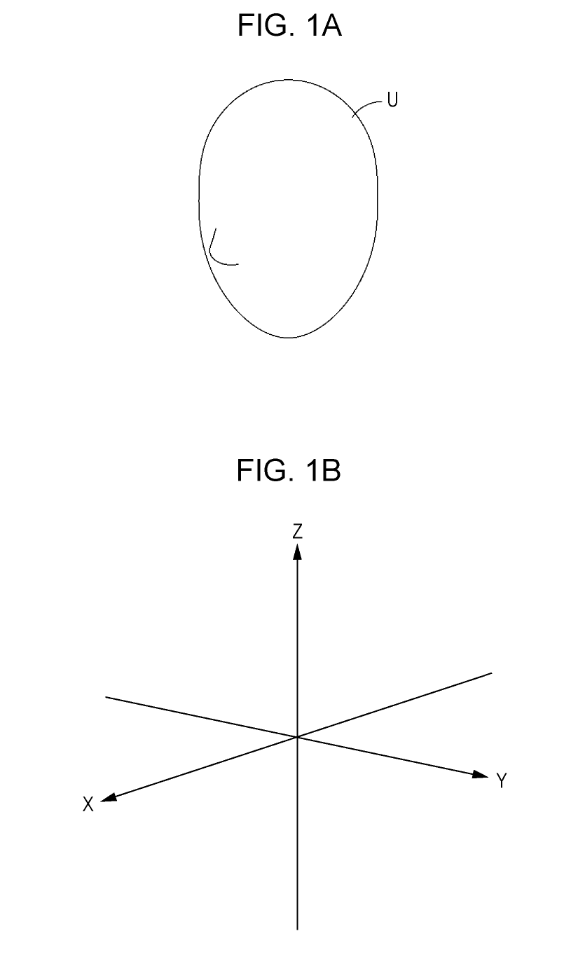

In addition, for ease of description, the X axis direction, the Y axis direction, and the Z axis direction are defined as illustrated in FIG. 1B, based on the user (who is wearing acceleration sensation presentation device) illustrated in FIG. 1A. The X axis direction corresponds to the front-back direction with respect to a user of the acceleration sensation presentation device, the Y axis direction which is orthogonal to the X axis direction corresponds to the horizontal direction with respect to the user, and the Z axis direction which is orthogonal to the X axis direction and the Y axis direction corresponds to the vertical direction with respect to the user in the acceleration sensation presentation device. In addition, each of directions of the front-back direction, horizontal direction, and vertical direction is defined based on a direction which the user views. As a matter of course, expressions of defining the directions are set for ease of description, and are not limited to directions which are exemplified in contents of the present disclosure.

### Configuration of Acceleration Sensation Presentation Device

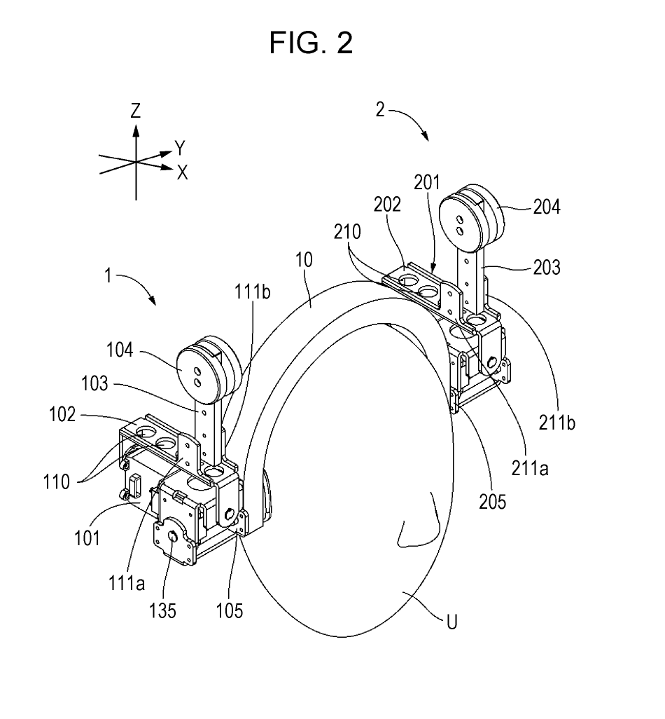

FIG. 2 is a diagram which describes an example of a configuration of the acceleration sensation presentation device according to the embodiment of the present disclosure. FIG. 2 illustrates a state in which two acceleration sensation presentation devices (acceleration sensation presentation device 1 and acceleration sensation presentation device 2) are mounted on a user U. For example, a head band 10 is attached to the head of the user U so as to go around a top of the head from one ear to the other ear. It is preferable to use plastic, or the like, for the head band 10 in order to reduce a weight, however, there is no limitation to this. A mechanism for adjusting the length of the head band 10 may be provided.

An acceleration sensation presentation device 1 is attached to a portion close to one end of the head band 10, and an acceleration sensation presentation device 2 is attached a portion close to the other end of the head band 10. In addition, the acceleration sensation presentation device 1 (the same is applied to acceleration sensation presentation device 2) may be fixed to the head band 10, and may be detachable from the head band 10. Each of the acceleration sensation presentation devices is located, for example, at positions in the vicinity of ears of the user U in a state in which the acceleration sensation presentation device is attached to the head band 10.

An example of a configuration of the acceleration sensation presentation device will be described. In the embodiment, the acceleration sensation presentation device 1 and the acceleration sensation presentation device 2 will be described by assuming that the devices have the same configuration. For this reason, hereinafter, a configuration of the acceleration sensation presentation device 1 will be mainly described.

The acceleration sensation presentation device 1 includes, for example, a box-shaped case (housing) 101, a movable unit 102, an arm unit 103 which is attached to the movable unit 102, a spindle 104 which is attached to an end portion (tip end) of the arm unit 103, and a mounting unit 105. Each of the constituent elements is configured of metal, for example. As a matter of course, a material thereof is not limited to a specific material, and a part thereof may be configured of a resin, or the like. The acceleration sensation presentation device 1 is attached to the head band 10 through the mounting unit 105.

The acceleration sensation presentation device 1 configures a two axes actuator as a whole. That is, a mechanism for moving the spindle 104 in the X axis direction, and a mechanism for moving the spindle 104 in the Y axis direction are built into the case 101. As the mechanism, it is possible to exemplify a servo motor. That is, a servo motor for moving the spindle corresponds to an example of a spindle driving unit. As a matter of course, the spindle driving unit is not limited to the servo motor, and it is possible to apply another motor, or the like. In addition, a servo motor for moving the spindle 104 in the X axis direction is appropriately referred to as a servo motor 120a, and a servo motor for moving the spindle 104 in the Y axis direction is appropriately referred to as a servo motor 120b.

In addition, according to the embodiment, it is configured such that the spindle 104 can be moved in two axial directions, however, in addition, it is also possible to configure so that the spindle is moved in the Z axis direction. The arm unit 103 and the spindle 104 may be moved in the Z axis direction by applying a voltage to a piezoelectric actuator, by attaching the piezoelectric actuator to the lower portion of the arm unit 103, for example.

The movable unit 102 is formed of a concave metal member which is open to the lower side, for example. For example, a plurality of holes 110 are formed on the base of the movable unit 102. For example, from the base of the movable unit 102, two side walls 111a and 111b are implanted upward so as to face each other, and a portion near lower end of the arm unit 103 is attached to one of the side walls (for example, side wall 111b). A portion near the lower end of the arm unit 103 is attached to the side wall 111b through mounting, or the like, using welding, screws, or the like.

The arm unit 103 stretches so as to stand up from the base of the movable unit 102. The arm unit 103 is formed of a plate-shaped member of metal, for example. The spindle 104 is formed when the vicinity of the tip end of the arm unit 103 has two spindles which are in approximately circular shapes attached thereto so as to be held therebetween. The two spindles in approximately the circular shape are attached to the tip end of the arm unit 103 through mounting, or the like, using welding, screws, or the like. The spindle 104 is formed of metal, for example. As a matter of course, it is not limited to a spindle of a specific material when being a material body with a predetermined weight.

Since the acceleration sensation presentation device 2 has the same configuration as that of the acceleration sensation presentation device 1, for example, only schematic descriptions thereof will be made. The acceleration sensation presentation device 2 is attached to the head band 10 through a mounting unit 205. The acceleration sensation presentation device 2 includes, for example, a box-shaped case 201, a movable unit 202, an arm unit 203, and a spindle 204. A servo motor which moves the spindle 204 in the X axis direction, and a servo motor which moves the spindle 204 in the Y axis direction are built into the case 201. In addition, the servo motor for moving the spindle 204 in the X axis direction will be appropriately referred to as a servo motor 220a, and the servo motor for moving the spindle 204 in the Y axis direction will be appropriately referred to as a servo motor 220b.

A plurality of holes 210 are formed on the base of the movable unit 202, and, for example, two side walls 211a and 211b are implanted upward so as to face each other from the base of the movable unit 202. The vicinity of the lower end of the arm unit 203 is attached to one of the side walls 211a and 211b (for example, side wall 211b). The arm unit 203 stretches so as to stand up from the base of the movable unit 202. The arm unit 203 is formed of a plate-shaped member of metal, for example. For example, the spindle 204 is formed when the vicinity of the tip end of the arm unit 203 has two spindles which are in approximately circular shapes attached thereto so as to be held therebetween. The spindle 204 is formed of metal, for example. As a matter of course, it is not limited to a spindle of a specific material when being a material body with a predetermined weight.

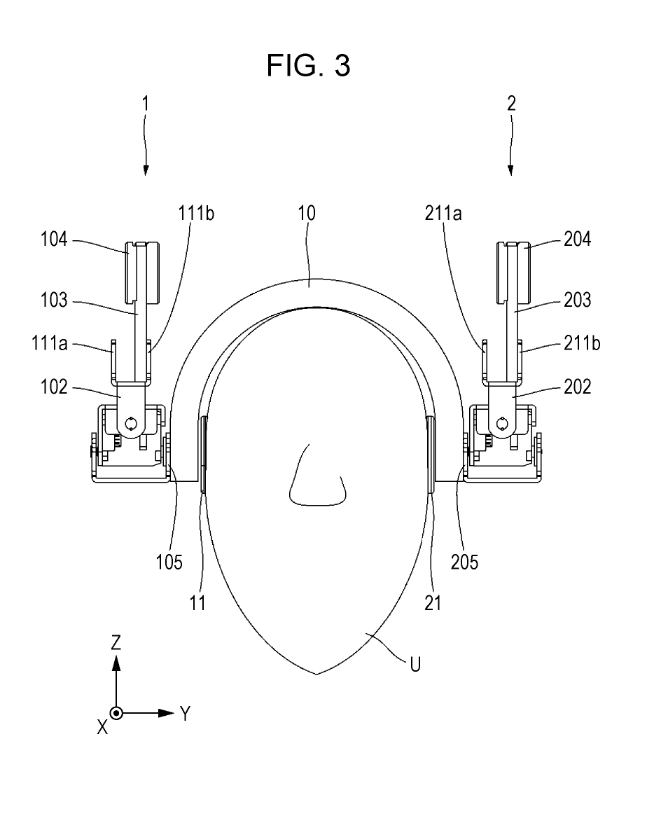

FIG. 3 is a diagram in which a user U in a state of wearing the acceleration sensation presentation devices 1 and 2 is viewed from the front. The examples of configurations of the acceleration sensation presentation devices 1 and 2 have been described, however, the configurations are merely examples, and are not limited to the exemplified configurations. It is possible to appropriately set a material, a size, or the like, of each configuration in a range in which a predetermined acceleration sensation can be presented to a user.

In addition, speakers 11 and 21 which come into contact with ears of the user U are provided in the head band 10 in the vicinity of each end portion thereof. Sound based on a predetermined sound signal is reproduced from the speakers 11 and 21. According to the embodiment, these speakers are mounted on the head band along with the acceleration sensation presentation device, however, there is no limitation to this.

### Example of Operation of Acceleration Sensation Presentation Device

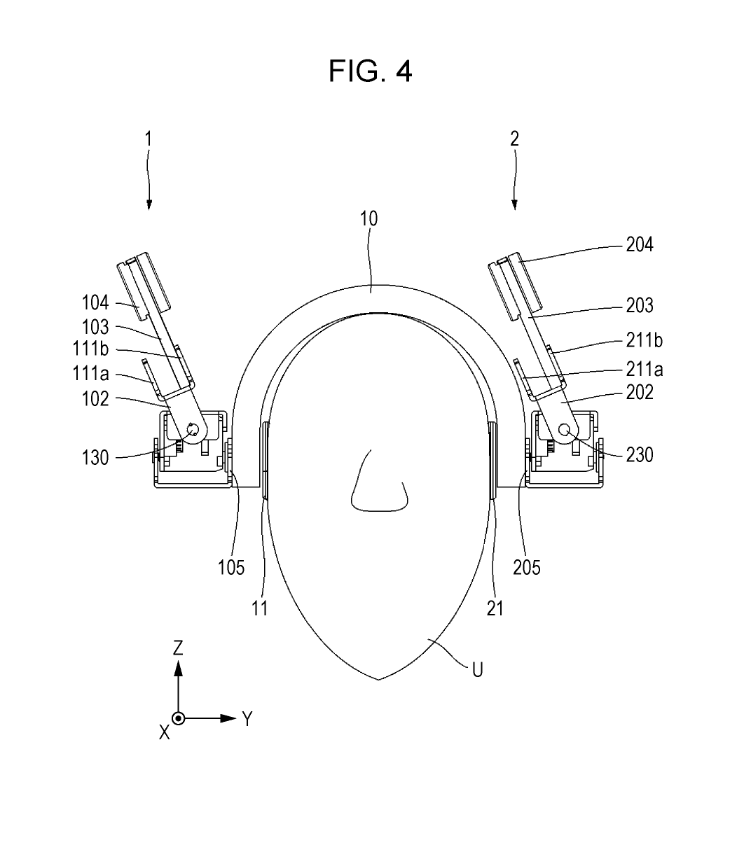

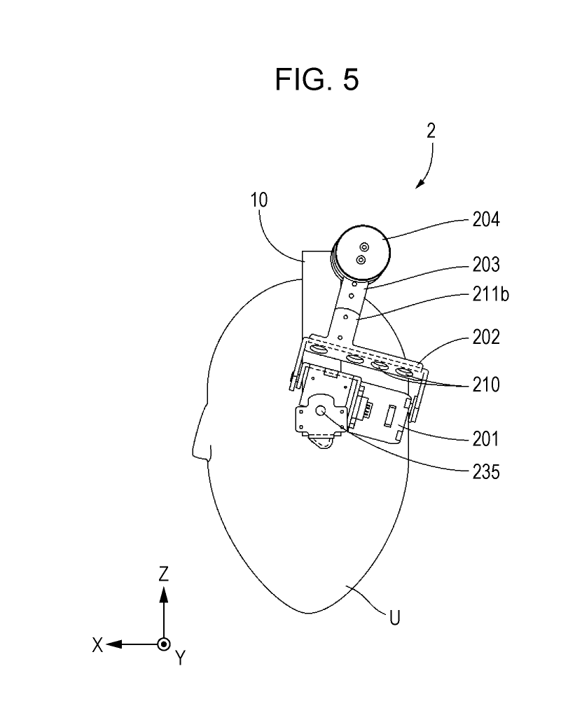

Subsequently, an example of operations of the acceleration sensation presentation device (motion of spindle) will be described with reference to FIGS. 4 and 5. A driving signal is supplied to the servo motor of the acceleration sensation presentation device 1 from the outside. The driving signal is a signal which is obtained based on predetermined acceleration information, for example.

FIG. 4 illustrates an example of a state in which the servo motor 120b of the acceleration sensation presentation device 1, and the servo motor 220b of the acceleration sensation presentation device 2 are operated according to the driving signal. The movable unit 102 rotates by a predetermined angle in the Y axis direction by having a shaft 130 as a rotating shaft according to the operation of the servo motor 120b of the acceleration sensation presentation device 1. In this manner, it is possible to move the spindle 104 in the Y axis direction. Similarly, the movable unit 202 rotates by a predetermined angle in the Y axis direction by having a shaft 230 as a rotating shaft according to the operation of the servo motor 220b of the acceleration sensation presentation device 2. In this manner, it is possible to move the spindle 204 in the Y axis direction.

A force in a direction different from a movement direction is generated along with the movement of the spindles 104 and 204. In the example illustrated in FIG. 4, a force in the left direction which is the opposite direction is generated when the spindles 104 and 204 move in the right direction when viewed from the user U. It is possible to present an acceleration sensation in the left direction to the user U due to the force.

FIG. 5 illustrates an example of a state in which the servo motor 220a of the acceleration sensation presentation device 2 is operated according to the driving signal. For example, the whole acceleration sensation presentation device 2 rotates by a predetermined angle by having a shaft 235 as a rotating shaft according to the operation of the servo motor 220a. It is possible to move the spindle 204 in the X axis direction according to the rotation of the whole acceleration sensation presentation device 2.

In addition, though it is not illustrated, it is possible to move the spindle 104 in the X axis direction according to the operation of the servo motor 120a of the acceleration sensation presentation device 1. That is, when the whole acceleration sensation presentation device 1 rotates by a predetermined angle by having the shaft 135 as the rotating shaft according to the operation of the servo motor 120a, it is possible to move the spindle 104 in the X axis direction.

In addition, an amount of movement and a movement speed of the spindle are appropriately set according to a mass of the spindle, an intensity of an acceleration sensation to be presented, or the like. For example, the spindle is moved toward a predetermined position instantaneously (for example, approximately several milliseconds). In addition, the acceleration sensation presentation device 2 may rotate by a predetermined angle in the Y axis direction by having the shaft 230 as a central shaft in a state in which the acceleration sensation presentation device 2 rotates by a predetermined angle in the X axis direction by having the shaft 235 as a central shaft.

The acceleration sensation presentation device according to the embodiment can be miniaturized since the device is configured of a small component such as a servo motor. Since a movement portion of the spindle is a space around the head, it is possible to make a limitation of the movement amount of the spindle small. It is possible to make a degree of freedom in design large by independently controlling each spindle of the plurality of acceleration sensation presentation devices.

### Example of Presentation of Acceleration Sensation Caused by Movement of Spindle

As described above, it is possible to appropriately move the spindle in the X axis direction and the Y axis direction, in the acceleration sensation presentation device according to the embodiment. It is possible to present various acceleration sensations to a user by appropriately combining movement directions of the spindles. Hereinafter, an example of an acceleration sensation which can be presented to a user along with the movement of the spindle will be described. In addition, in the following description, a movement direction of the spindle is denoted by an arrow, and an acceleration sensation which is felt by the user due to the movement of the spindle is denoted by an arrow with slanted lines.

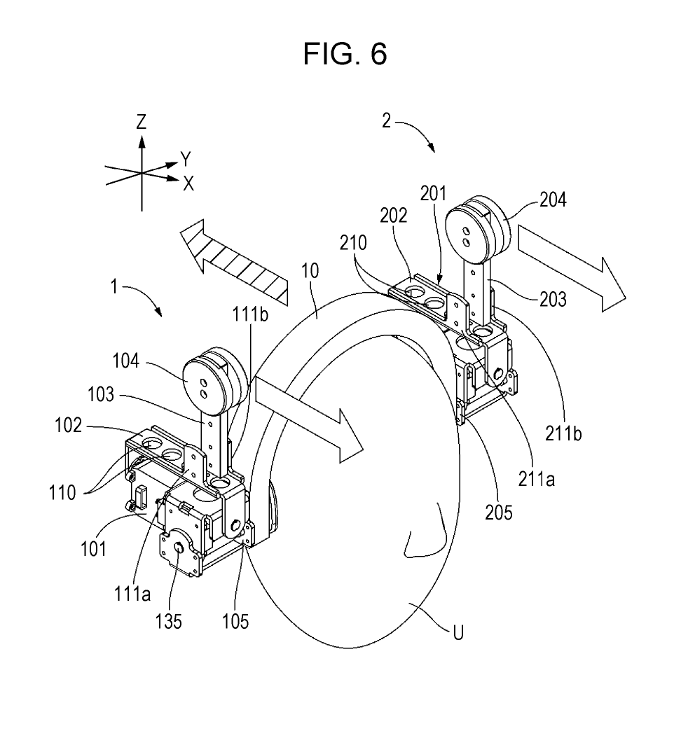

As illustrated in FIG. 6, for example, the acceleration sensation presentation devices 1 and 2 move the spindles 104 and 204 in the same direction in the X axis direction (for example, forward from user) at the same time, or at approximately the same time (referred to as approximately the same time, appropriately) in which some error is permitted. A force (reaction force) is generated in a direction opposite to the movement direction of the spindle along with the movement of the spindles 104 and 204. According to the force, it is possible to present an acceleration sensation to the rear side with respect to the user U.

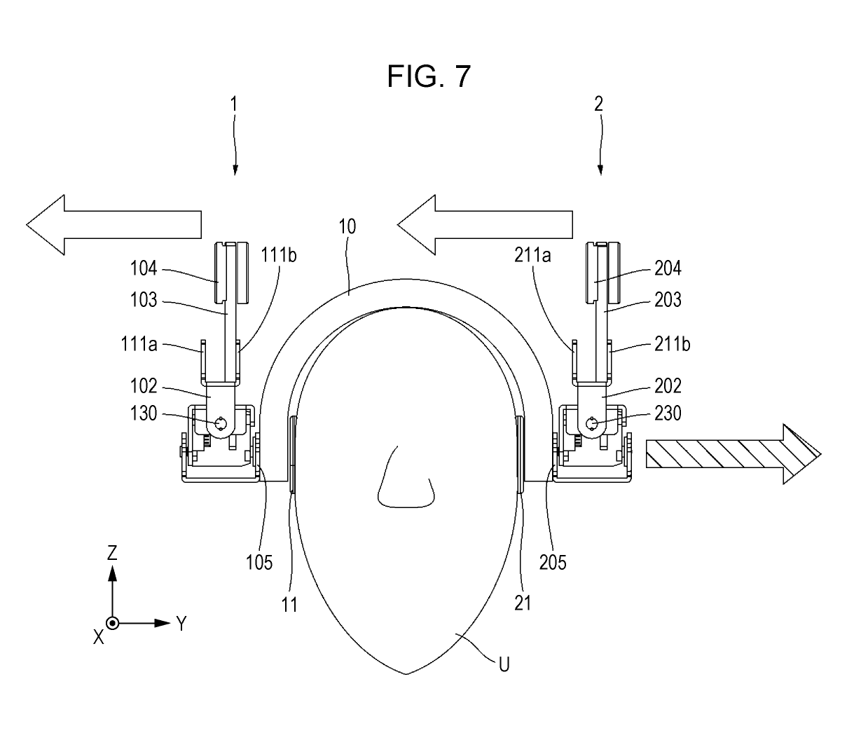

As illustrated in FIG. 7, for example, the acceleration sensation presentation devices 1 and 2 move the spindles 104 and 204 in the same direction in the Y axis direction (for example, right direction when being viewed from user) at approximately the same time. A force is generated in a direction opposite to the movement direction of the spindle along with the movement of the spindles 104 and 204. According to the force, it is possible to present an acceleration sensation in the left direction with respect to the user U.

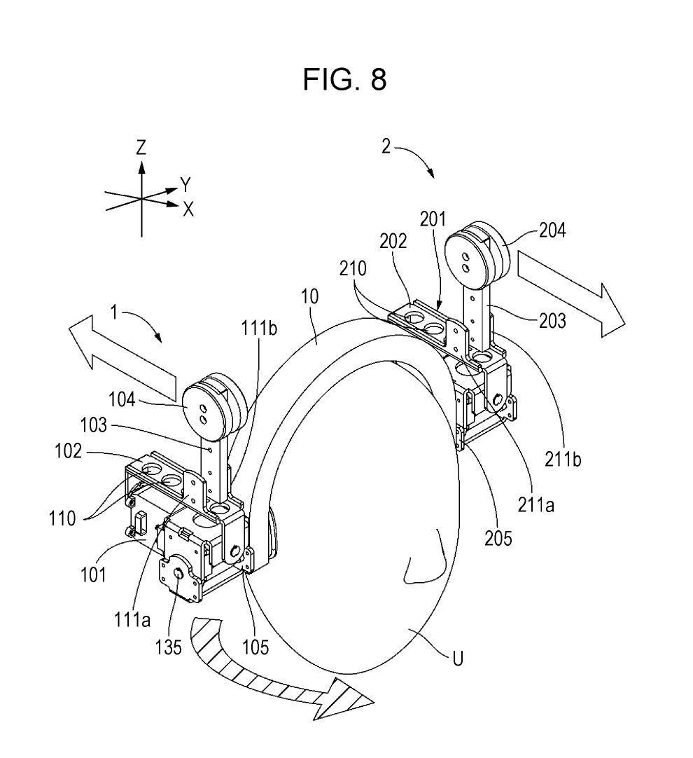

As illustrated in FIG. 8, for example, the acceleration sensation presentation device 1 moves the spindle 104 to the rear side in the X axis direction, and the acceleration sensation presentation device 2 moves the spindle 204 forward in the X axis direction at approximately the same time. Along with the movement of the spindles 104 and 204, forces to the front and the rear are generated. According to the forces, it is possible to present an acceleration sensation in an anticlockwise direction in which a line connecting a chin and a top of head is set to an axis to the user U. In addition, on the contrary, it is possible to present an acceleration sensation in a clockwise direction, in which the line connecting the chin and the top of the head is set to an axis, to the user U, when the acceleration sensation presentation device 1 moves the spindle 104 forward in the X axis direction, and the acceleration sensation presentation device 2 moves the spindle 204 backward in the X axis direction at approximately the same time.

As an assumed technology (not related art), a technology in which one spindle is caused to correspond to one direction (for example, X axis direction), a force is generated in a direction different from a movement direction by moving the spindle, and an acceleration sensation is provided to a user is also taken into consideration. However, since there is only one spindle in one direction, it is not easy to provide to the user an acceleration sensation of looking back by setting the line which connects the top of the head and the chin, in particular, as an axis. However, according to the embodiment, since it is a system configuration in which at least two spindles are provided, and the two spindles are configured so as to move in a different direction in the same axis direction, as well, it is possible to provide the acceleration sensation of looking back for the user.

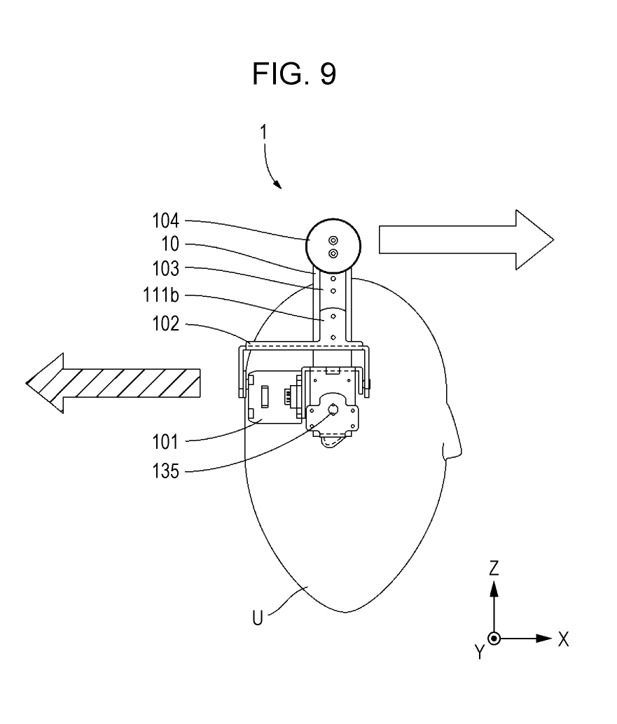

In addition, as illustrated in FIG. 9, only one of the spindles 104 and 204 (for example, only spindle 104) may be moved forward or backward in the X axis direction. Even in this case, a force in the rear side is generated in the vicinity of the right side of the user U due to the movement of the spindle 104, and the user U can feel the acceleration sensation in the clockwise direction in which the line connecting the chin and the top of the head is set to the axis.

### Use Example of Acceleration Sensation Presentation Device

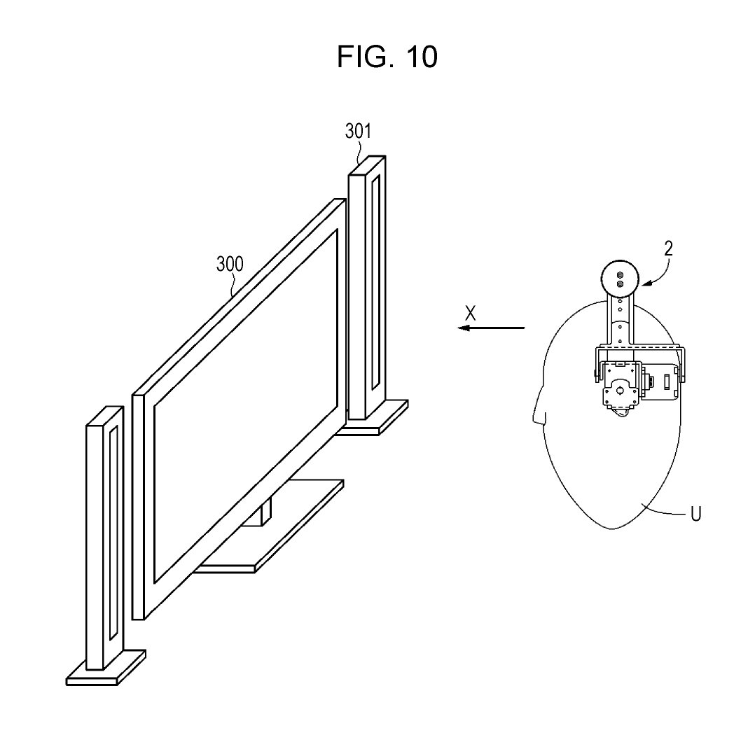

Subsequently, a use example of the acceleration sensation presentation device will be described. As described above, the acceleration sensation presentation device according to the embodiment can be mounted in the vicinity of the head, for example, in the vicinity of ears of the user U. As illustrated in FIG. 10, for example, it is possible to present an acceleration sensation to the user U in synchronization with video contents which are displayed on a display 300. That is, it is configured such that a driving signal is supplied to a servo motor of each acceleration sensation presentation device in synchronization with the video contents which are displayed on the display 300. In addition, in FIG. 10, only the acceleration sensation presentation device 2 is displayed from the acceleration sensation presentation devices 1 and 2.

In addition, it is possible to present an acceleration sensation to the user U by appropriately moving the spindles 104 and 204 in synchronization with the video contents of the display. That is, it is possible for the user U to experience the acceleration sensation which is synchronized with the video contents along with a video which is displayed on the display 300, and sound which is output from the speaker 301, and to enjoy a sensation of virtual reality. In addition, the example illustrated in FIG. 10 is merely an example, and there is no limitation to this. Differently from the display 300 and the speaker 301 illustrated in FIG. 10, it is also possible to present an acceleration sensation to the user U in synchronization with the video which is displayed on the display even in a game machine which is installed in a game center, an amusement park, or the like, and a movie theater, or the like, for example.

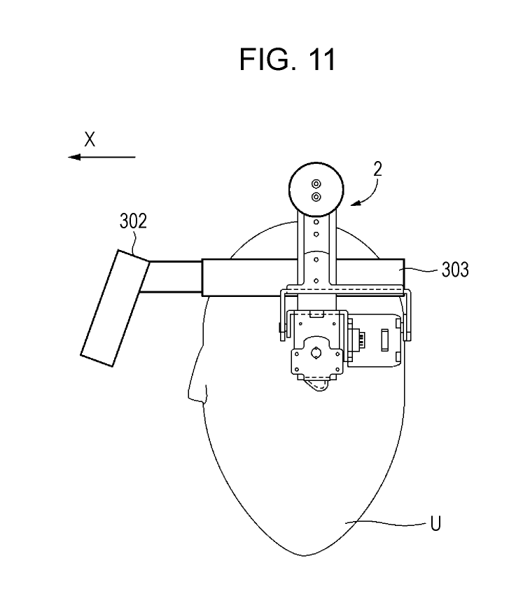

In FIG. 11, another use example of the acceleration sensation presentation device is illustrated. In FIG. 11, only the acceleration sensation presentation device 2 from the acceleration sensation presentation devices 1 and 2 is illustrated. As another use example, it is possible to use the acceleration sensation presentation device along with a head mounted display 302. As illustrated in FIG. 11, the head mounted display 302 is provided at the front side of the user in the X axis direction. The head mounted display 302 is supported so that the display is located in the vicinity of the front side of the user U. The head mounted display 302 is supported by a head band 303 which is mounted around the head, for example. The head band 303, and the head band 10 which supports each of the acceleration sensation presentation devices may be integrally configured.

The user U can view a video which is displayed on the head mounted display 302 when a video signal is supplied to the head mounted display 302. The user U can hear sound which is output from each speaker when a sound signal is supplied to the speakers 11 and 21 which are provided in the head band 10. In this manner, it is possible to provide a video, sound, and an acceleration sensation for the user U altogether. As a result, differently from a device using a stage in the related art, it is possible for the user U to experience a virtual reality using a small acceleration sensation presentation device even at home, or the like.

Subsequently, another configuration of the head mounted display in FIG. 11 will be described. Here, the acceleration sensation presentation device 2 is not illustrated in order to simplify description, however, it is assumed that the head mounted display is used in cooperation with the acceleration sensation presentation device 2.

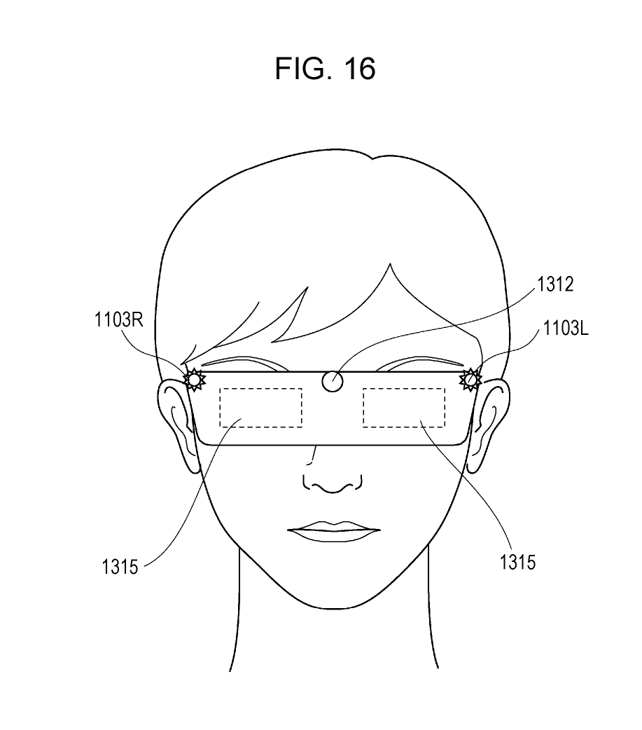

FIG. 16 illustrates a state in which a user who is wearing a head mounted display 1100 on the head is viewed from the front.

The head mounted display 1100 can provide a sense of immersion for a user who is viewing an image by directly covering the eyes of the user when the user is wearing the head mounted display on the head or a face. In addition, the head mounted display is different from a see-through type, and it is not possible for a user who is wearing the head mounted display 1100 to directly view scenery in a real world. However, it is possible for the user to indirectly view scenery in the real world (that is, displaying scenery using video see-through) when an external camera 1312 which photographs scenery in the gaze direction of the user is provided, and an imaged image thereof is displayed. As a matter of course, it is possible to cause a virtual display image such as an Augmented Reality (AR) image to be viewed by being overlapped with a video see-through image. In addition, since the display image is not viewed from the outside (that is, by others), it is easy to guard privacy when displaying information.

The head mounted display 1100 illustrated in FIG. 16 is configured so as to directly cover left and right eyes of a user who is wearing the display. A display panel which the user views (not illustrated in FIG. 16) is arranged at a position facing the left and right eyes inside a main body of the head mounted display 1100. The display panel is configured of, for example, a micro display such as an organic EL element or a liquid crystal display, and a laser scanning display such as a direct retinal imaging display.

The external camera 1312 for inputting a peripheral image (field of vision of user) is provided at approximately a center of the front face of the main body of the head mounted display 1100. In addition, microphones 1103L and 1103R are respectively provided in the vicinity of both of left and right ends of the main body of the head mounted display 1100. It is possible to separate ambient noise or talking voice of others by only recognizing a voice at the center (user's voice), by having the approximately bisymmetric microphones 1103L and 1103R, and it is possible to prevent a malfunction at a time of operating using a sound input, for example.

In addition, a touch panel 1315 on which it is possible for a touch input using a fingertip to be performed by a user is arranged outside the main body of the head mounted display 1100. A pair of left and right touch panels 1315 is provided in the illustrated example, however, a single or three or more touch panels 1315 may be provided.

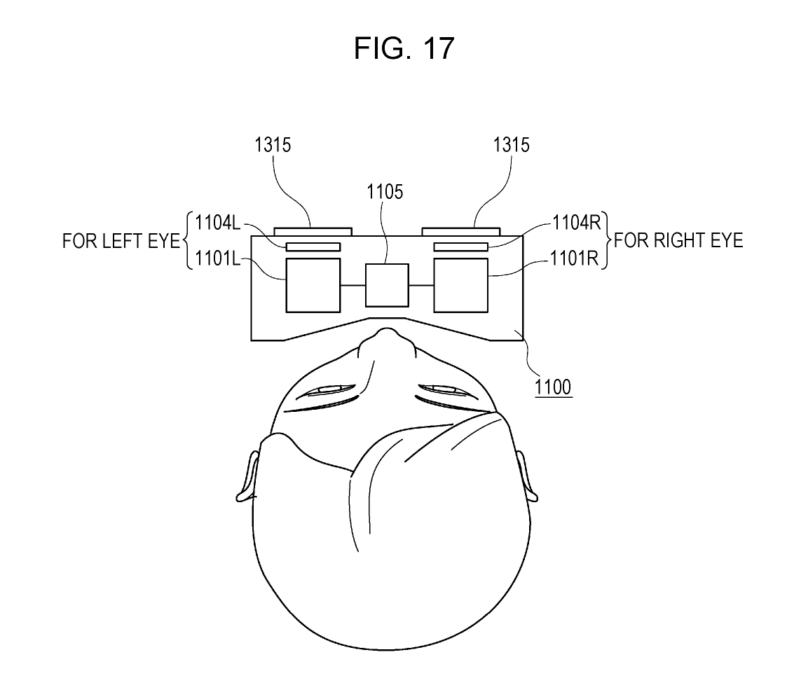

FIG. 17 illustrates a state in which the user who is wearing the head mounted display 1100 illustrated in FIG. 16 is viewed from a top. However, the acceleration sensation presentation device 2 is not illustrated in order to simplify description. The illustrated head mounted display 1100 includes a display panel 1104L for the left eye, and a display panel 1104R for the right eye on the side surface which faces a face of the user. The display panels 1104L and 1104R are configured of a micro display such as an organic EL element, or a liquid crystal display, and a laser scanning display such as a direct retinal imaging display, for example. A display image on the display panels 1104L and 1104R is viewed by the user as an enlarged virtual image when passing through virtual optical units 1101L and 1101R. In addition, since there is an individual difference in height and width of the eyes in each user, it is necessary to perform aligning of each display system on the left and right eyes of the user wearing the display. The example illustrated in FIG. 17 is equipped with an eye width adjusting mechanism 1105 between the display panel 1104L for the left eye and the display panel 1104R for the right eye.

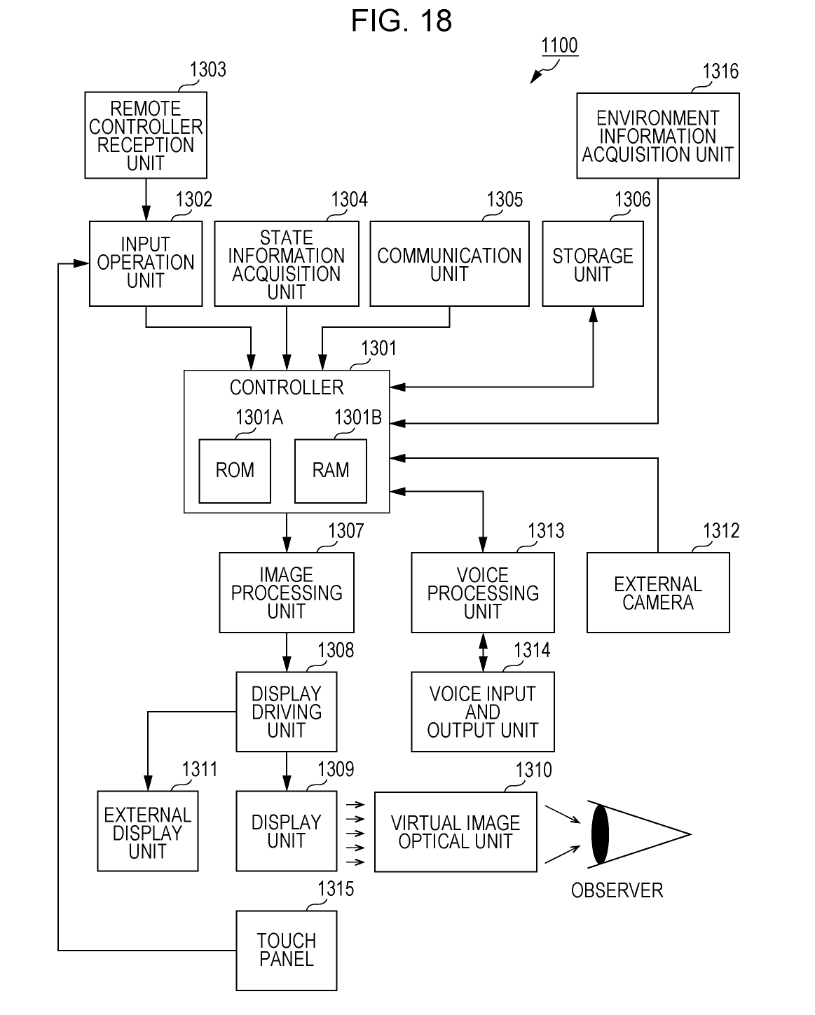

An internal configuration example of the head mounted display 1100 is illustrated in FIG. 18. Hereinafter, each unit will be described.

A control unit 1301 includes a Read Only Memory (ROM) 1301A, or a Random Access Memory (RAM) 1301B. A program code or various data which is executed by the control unit 1301 is stored in the ROM 1301A. The control unit 1301 collectively controls an image display, and all of operations of the head mounted display 1100 by executing a program which is downloaded to the RAM 1301B. As a program or data which is stored in the ROM 1301A, there is a display control program of an image such as reproducing of moving image contents, a communication control program which enables a user who is viewing a display image to communicate with a real world, identification information which is unique to the head mounted display 1100, user attribute information of a user who uses the head mounted display 1100, or the like.

An input operation unit 1302 includes one or more operators (none is illustrated) such as a key, a button, a switch, or the like, with which a user performs an input operation, receives an instruction of the user which is performed through the operator, and outputs a result thereof to the control unit 1301. In addition, the input operation unit 1302 receives an instruction of the user which is a remote control command received in the remote control receiving unit 1303, and outputs the instruction to the control unit 1301.

In addition, when a touch operation is performed with respect to the touch panel 1315 which is arranged outside the main body of the head mounted display 1100 by the user using a fingertip, the input operation unit 1302 outputs input information such as coordinate data of a touched position of a fingertip to the control unit 1301.

A state information obtaining unit 1304 is a functional module which obtains state information of the main body of the head mounted display 1100, or state information of a user who is wearing the head mounted display 1100. The state information obtaining unit 1304 may be equipped with various sensors for detecting own state information, or may obtain state information from an external device (for example, smart phone or wristwatch which user wears, or other multifunctional terminal) which includes a proportion of all of the sensors through a communication unit 1305 (which will be described later).

The state information obtaining unit 1304 obtains a position of the head or a posture of a user, or information of the posture, for example. In order to obtain the position and posture information, the state information obtaining unit 1304 may include any one of a gyro sensor, an acceleration sensor, a Global Positioning System (GPS) sensor, a geomagnetic sensor, a Doppler sensor, an infrared sensor, and a radio wave sensor, or a combination of two or more sensors with consideration for strengths and weaknesses of each sensor. In addition, the state information obtaining unit 1304 may use information which is provided from various infrastructures such as mobile phone base station information, or PlaceEngine (registered trademark) information (electric measurement information from wireless LAN access point) by combining thereof when obtaining position and posture information.

In addition, the state information obtaining unit 1304 obtains information on, for example, a work state of a user (whether or not wearing head mounted display 1100), a behavior state of the user (movement state such as at a standstill, walking, or running, gestures using hand or fingertip, state of opening or shutting of eyelids, gaze direction, size of pupils), a mental state (whether or not user is immersed while viewing display image), and a physical state as state information of the user who is wearing the head mounted display 1100. In addition, the state information obtaining unit 1304 may include a mounted sensor which is formed of an external camera 1312, a mechanical switch, or the like, various state sensors such as an internal camera which photographs a face of a user, a gyro sensor, an acceleration sensor, a speed sensor, a pressure sensor, a temperature sensor which detects a body temperature or a temperature, a sweat sensor, a pulse sensor, a myogenic potential sensor, an eye potential sensor, an electroencephalographic sensor, an expiration sensor, and a gas/ion concentration sensor, and a timer (none is illustrated) in order to obtain the state information from a user.

An environment information obtaining unit 1316 is a functional module which obtains information related to the main body of the head mounted display 1100, or the environment which surrounds a user who is wearing the head mounted display 1100. As the information related to the environment referred to here, there is sound, an air volume, a temperature, an atmospheric pressure, an atmosphere (smoke, dense fog, electromagnetic waves to which head mounted display 1100 or user is exposed (ultraviolet rays, blue light, and electric wave), heat rays (infrared rays), radiation, carbon monoxide, carbon dioxide, oxygen, nitrogen compounds (nicotine) in the atmosphere, nitrogen oxides (NOx) or hydrocarbons (volatile organic compounds: VOC) which drifts in the atmosphere, or photochemical smog which is generated when nitrogen oxides or hydrocarbons are subjected to a photochemical reaction due to an influence of ultraviolet rays, fine particles such as a particulate matter, pollen, or house dust, a toxic chemical substance such as asbestos), or other environmental factors. The environment information obtaining unit 1316 may be equipped with various environmental sensors including a sound sensor or an air volume sensor in order to detect environmental information. It is possible to include the above described microphones 1103L and 1103R, or the external camera 1312 in the environmental sensors. Alternatively, the environment information obtaining unit 1316 may obtain the environment information from an external device (for example, smart phone or wristwatch which user wears, or other multifunctional terminal) which includes a proportion of all of the sensors through the communication unit 1305 (which will be described later).

The external camera 1312 is arranged at approximately a center of the front face of the main body of the head mounted display 1100 (refer to FIG. 16), for example, and can photograph a peripheral image. A user can adjust zooming of the external camera 1312 through an operation of the input operation unit 1302, a size of a pupil which is recognized using an internal camera, a myogenic potential sensor, or the like, or a sound input. In addition, it is possible to photograph an image of own gaze of the user, that is, an image in the gaze direction of the user using the external camera 1312 by performing a posture control in the direction of panning, tilting, or rolling of the external camera 1312 according to a gaze direction of the user which is obtained in the state information obtaining unit 1304. It is possible to display and output a photographed image of the external camera 1312 on the display unit 1309, to transmit the photographed image from the communication unit 1305, or to store in a storage unit 1306.

It is more preferable to configure the external camera 1312 to be a plurality of cameras so at to obtain three-dimensional information of a peripheral image using parallax information. In addition, even in a case of using one camera, it is also possible to obtain three-dimensional information of a peripheral image from calculated parallax information by performing photographing while moving a camera using Simultaneous Localization and Mapping (SLAM) image recognition, and calculating the parallax information (for example, refer to Japanese Unexamined Patent Application Publication No. 2008-304268) using a plurality of frame images which are in a vicinity in terms of time.

The external camera 1312 can also be used as a distance sensor, since the external camera can obtain three-dimensional information. Alternatively, for example, a distance sensor which is formed of an inexpensive device such as a Position Sensitive Detector (PSD) which detects a reflection signal from an object may be used together with the external camera 1312. The external camera 1312 or the distance sensor can be used in order to detect a physical position, a posture, or a shape of a user who is wearing the head mounted display 1100.

The communication unit 1305 performs communication processing with the external device, and processes of modulation and demodulation, and encoding and decoding of the communication signal. As the external device, there is a contents reproducing device (Blu-ray disc, or DVD player) which supplies contents to be viewed when a user uses the head mounted display 1100, or a streaming server. In addition, the control unit 1301 sends out transmission data to the external device from the communication unit 1305.

A configuration of the communication unit 1305 is arbitrary. For example, it is possible to configure the communication unit 1305 according to a communication system which is used in a transceiving operation with the external device which is a communication partner. The communication system may be any one of a wired system and a wireless system. As a communication standard here, there is a Mobile High-definition Link (MHL), a Universal Serial Bus (USB), a High Definition Multimedia Interface (HDMI) (registered trademark), Wireless Fidelity (Wi-Fi) (registered trademark), a Bluetooth (registered trademark) communication, a Bluetooth (registered trademark) Low Energy (BLE) communication, a super low consumption electricity wireless communication such as ANT, a mesh network which is standardized using IE EE802.11s, or the like. Alternatively, the communication unit 1305 may be a cellular radio transceiver which operates according to a standard such as Wideband Code Division Multiple Access (W-CDMA), or Long Term Evolution (LTE), for example.

The storage unit 1306 is a mass storage device which is configured of a Solid State Drive (SSD), or the like. The storage unit 1306 stores an application program which is executed in the control unit 1301, or various data. For example, contents which a user views on the head mounted display 1100 are stored in the storage unit 1306.

An image processing unit 1307 further performs signal processing such as an image quality correction with respect to an image signal which is output from the control unit 1301, and converts into a resolution corresponding to a screen of the display unit 1309. In addition, a display driving unit 1308 sequentially selects pixels in the display unit 1309 in each row, performs sequential line scanning, and supplies a pixel signal based on the image signal which was subjected to the signal processing.

The display unit 1309 includes a micro display such as an organic Electro-Luminescence (EL) element, or a liquid crystal display, for example, or the display panels 1104L and 1104R (which are described above) which are configured of a laser scanning display such as a direct retinal imaging display. A virtual optical unit 1310 performs enlarging projection of a display image of the display unit 1309, and allows a user to view the image as an enlarged virtual image. In addition, as a display image which is output from the display unit 1309, there is an image of a virtual world such as commercial contents which are supplied from a contents reproducing device (Blu-ray disc or DVD player) or a streaming server, or an image in the real world which is photographed using the external camera 1312.

In addition, as an arbitrary constituent element of the head mounted display 1100, an external display unit 1311 may be included. The external display unit 1311 displays an external image which can be viewed by an outsider who is not wearing the head mounted display 1100. The external image may be the same image which is displayed on the display unit 1309 (that is, internal image), or may be a different image. The image processing unit 1307 also performs a signal correction such as an image quality correction of the external image. In addition, the display driving unit 1308 sequentially selects pixels in the external display unit 1311 in each row, performs sequential line scanning, and supplies a pixel signal based on the image signal which was subjected to the signal processing.

A sound processing unit 1313 further performs a sound quality correction or sound amplification with respect to a sound signal which is output from the control unit 1301, or signal processing of the input sound signal, or the like. In addition, a sound input-output unit 1314 performs outputting of sound which was subjected to sound processing to the outside, and performs inputting of sound from the microphones 1103L and 1103R (which are described above).

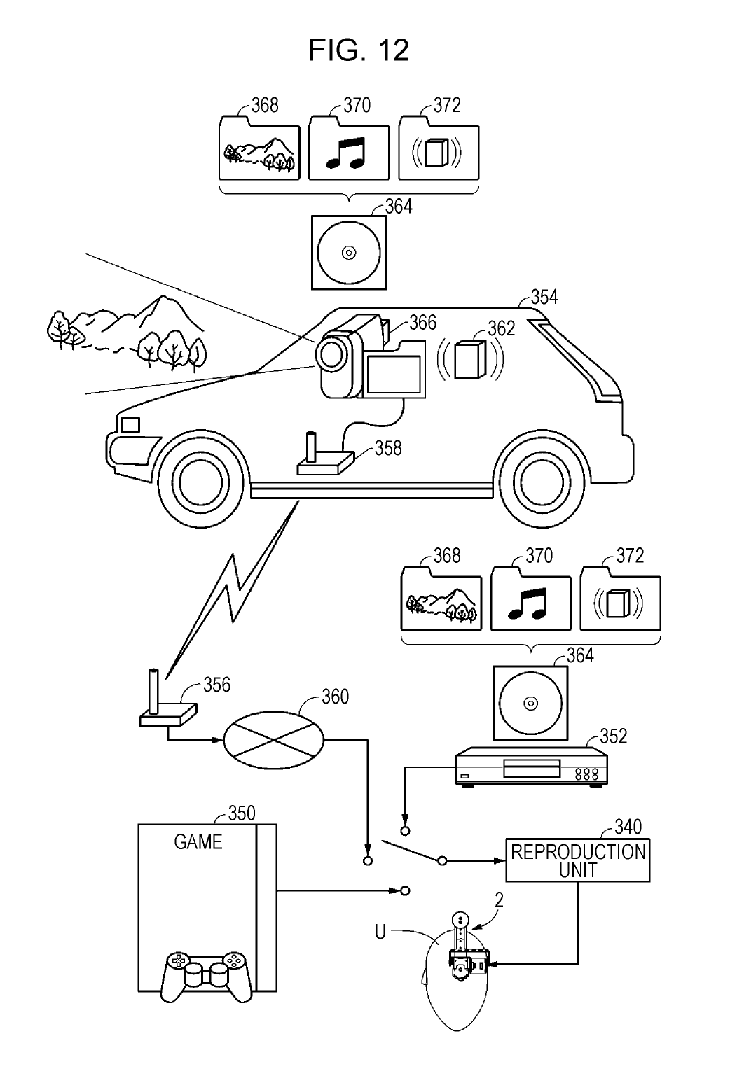

Subsequently, an example of a specific system in which the acceleration sensation presentation device is used will be described. FIG. 12 illustrates an example of a system in which the acceleration sensation presentation device is used. The example in FIG. 12 is an example of a system in which the acceleration sensation presentation device along with the head mounted display 302, and the speakers 11 and 21 are used. In addition, in FIG. 12, illustrations of the head mounted display 302, and the speakers 11 and 21 are appropriately omitted, and only the acceleration sensation presentation device 2 from the acceleration sensation presentation devices 1 and 2 is illustrated. In addition, the acceleration sensation presentation device 1 is mainly described, however, the same processing is performed with respect to the acceleration sensation presentation device 2.

As illustrated in FIG. 12, the acceleration sensation presentation device 1 obtains a driving signal from a reproduction unit 340. The reproduction unit 340 may be incorporated in the acceleration sensation presentation device 1, or may be incorporated in a device which is different from the acceleration sensation presentation device 1. The reproduction unit 340 obtains an acceleration signal (also referred to as acceleration information, appropriately), a video signal, a sound signal, or the like, from the external device. As the external device, there is an imaging apparatus, a device for riding which includes the imaging apparatus, a device for riding as a target of a remote control, a robot as a target of a remote operation, a model as a target of a remote operation, a game machine which executes a game program, a recording medium, or the like.

The reproduction unit 340 obtains acceleration information, or the like, from these external devices through a network such as the Internet, for example. The reproduction unit 340 performs various processes such as a decoding process, a synchronization process, and an amplification process with respect to the obtained acceleration information, or the like. In addition, the reproduction unit 340 can also transmit a software program of a game, or a video, sound, an acceleration signal, and the like, which are recorded in a recording medium such as a Digital Versatile Disc (DVD) to the acceleration sensation presentation device 1.

The reproduction unit 340 can transmit a video signal which is received through an information processing device or a network, for example, to the head mounted display 302. In this manner, it is possible to display a video based on the video signal on the head mounted display 302. In addition, the reproduction unit 340 can transmit a sound signal which is received through an information processing device or a network, for example, to the speakers 11 and 21. In this manner, it is possible to output sound based on the sound signal to the speakers 11 and 21.

In addition, the reproduction unit 340 generates a driving signal which is necessary for moving a spindle based on the acceleration information which is received through a network, for example. The acceleration information is supplied to the reproduction unit 340 at a predetermined timing. The reproduction unit 340 appropriately supplies the generated driving signal to a spindle driving unit of the acceleration sensation presentation device 1 (servo motors 120a and 120b, here), and a spindle driving unit of the acceleration sensation presentation device 2 (servo motors 220a and 220b, here). The driving signal may be supplied in a wired manner, or a wireless manner.

For example, the spindle driving unit of the acceleration sensation presentation device 1 is operated according to the supplied driving signal, and due to this, the spindle 104 moves in a predetermined direction. Similarly, for example, the spindle driving unit of the acceleration sensation presentation device 2 is operated according to the supplied driving signal, and due to this, the spindle 204 moves in a predetermined direction. Due to a force which is generated along with the movement of the spindle, it is possible to provide an acceleration sensation in a predetermined direction for the user U. That is, it is possible to provide a video, sound, and an acceleration sensation to the user U in a synchronized manner, using the system in which the acceleration sensation presentation device is used. In this manner, it is possible for the user U to enjoy a sensation of virtual reality in which it is possible to experience a video, sound, and an acceleration sensation at the same time.

For example, in the example illustrated in FIG. 12, the user U can experience (simulation experience) the same acceleration sensation as that of a driver of a car 354 based on various signal information from the car 354 which is running in a remote location. Specifically, the simulation experience is realized by providing an imaging apparatus 366 which images scenery in front of the car 354, in the car 354. Here, the imaging apparatus 366 includes, for example, an imaging unit which images an advancing direction of the car 354, and records the advancing direction as a video signal, and a sound recording unit which records sound which is input through a speaker, or the like, as a sound signal.

In addition, an acceleration sensor 362 is provided in the imaging apparatus 366. The acceleration sensor 362 is a sensor for measuring gravitational acceleration which is generated due to a movement of the car 354, and it is possible to use a Micro Electro Mechanical Systems (MEMS) sensor of piezoresistance type, electrostatic type, heat detection type, or the like, or an acceleration sensor of piezoelectric type, electrodynamic type, or the like. As a matter of course, these are examples of the acceleration sensor 362, and when it is a sensor which can measure gravitational acceleration which is generated due to a movement of the car 354, the sensor is not limited to a sensor of a specific system.

The acceleration sensor 362 can detect an acceleration vector which a driver receives with respect to the ground from a total acceleration vector of X, Y, and Z, by setting the front-back direction of the car 354 to the X direction, the horizontal direction of the car 354 to the Y direction, and the vertical direction of the car 354 to the Z direction. In addition, the acceleration sensor 362 may be provided in the car 354 separately from the imaging apparatus 366.

As described above, a signal of a video which is imaged using the imaging apparatus 366 of the car 354 and a sound signal, and an acceleration signal which is detected by the acceleration sensor 362 are transmitted to the reproduction unit 340 from a transmitter 358 which is provided in the car 354. In addition, in the example illustrated in FIG. 12, the reproduction unit 340 can receive various signals from the car 354 in a remote location through a receiver 356, the Internet 360, or the like. As a matter of course, the example illustrated in FIG. 12 is merely an example, and it is also possible for the reproduction unit 340 to directly receive various signals using a wired connection, for example.

The acceleration sensation presentation device 1 can also provide a sensation of virtual reality for the user U by receiving various information from a video reproducing device 352 such as a DVD recorder, or a hard disk recorder through the reproduction unit 340.

In the example illustrated in FIG. 12, the reproduction unit 340 receives a video signal, a sound signal, an acceleration signal, or the like, from the video reproducing device 352, and also can transmit the signals to the acceleration sensation presentation device 1. For example, various data items which are detected by the imaging apparatus 366, or the acceleration sensor 362 in the car 354 can be recorded in a recording medium 364 such as a DVD, an SD card, a memory stick (registered trademark), a tape, or the like, as video data 368, sound data 370 and acceleration data 372, by being synchronized. Accordingly, the video reproducing device 352 can transmit video data 368, the sound data 370, the acceleration data 372, and the like, which are recorded in the recording medium 364 to the acceleration sensation presentation device 1 through the reproduction unit 340. In addition, in this case, the reproduction unit 340 can be included in the video reproducing device 352, and also can be included in the acceleration sensation presentation device 1.

In this manner, it is possible to display a video on the head mounted display 302 based on various data items which are recorded in the recording medium 364, and to output sound from the speakers 11 and 21. In addition, it is possible to present an acceleration sensation to the user U by displacing the spindle of the acceleration sensation presentation device 1. As a result, it is possible to make the user U experience (simulation experience) scenery which is viewed by a driver of the car 354, sound which the driver hears, a sensation which is experienced by the driver, or the like.

In addition, the acceleration sensation presentation device 1 also can provide a sensation of virtual reality for the user U by receiving various signals from a game machine 350 through the reproduction unit 340.

In the example illustrated in FIG. 12, the reproduction unit 340 receives a video signal, a sound signal, an acceleration signal, and the like, from the game machine 350, and also can transmit the signals to the acceleration sensation presentation device 1. For example, it is also possible to incorporate an acceleration signal corresponding to a movement of a character, a vehicle, or the like, in advance, in a program of game software which is operated in the game machine 350. In this manner, the game machine 350 can transmit the video signal, the sound signal, the acceleration signal, and the like, which are incorporated in the program of the software of the game through the reproduction unit 340 to the acceleration sensation presentation device 1. In addition, in this case, the reproduction unit 340 can be provided in the game machine 350, or can be provided in the acceleration sensation presentation device 1.

In this manner, a video is displayed on the head mounted display 302 based on various data incorporated in the program of the software which is operated in the game machine 350, and sound is output from the speakers 11 and 21. In addition, when the spindle in the acceleration sensation presentation device 1 is moved, it is possible to present an acceleration sensation to the user U. As a result, it is possible for the user U to enjoy a sensation of virtual reality corresponding to a movement of a character or a vehicle of a game.

### Conclusion

Hitherto, the configuration, or the like, of the acceleration sensation presentation device according to the embodiment of the present disclosure has been described. In addition, for easy understanding, an example of a correlation with claims will be described below. As a matter of course, the correlation below is an example, and can be changed according to a correction, or the like, in the future.

The acceleration sensation presentation device according to the embodiment is attached to the vicinity of the head of a user, for example, to the vicinity of the ears. The acceleration sensation presentation device includes a spindle (for example, spindle 104). When the spindle is moved in a predetermined direction, a force (reaction force) can be generated in a direction different from the predetermined direction. As a spindle driving unit, it is possible to exemplify the servo motors 120a and 120b.

The spindle driving unit moves the spindle in at least one direction of the front-back direction, the horizontal direction, and the vertical direction with respect to the user. According to the embodiment, it is configured such that the spindle 104 can be moved in the front-back direction and the horizontal direction using the servo motors 120a and 120b. As described above, it is also possible to use an actuator, or the like, or to move the spindle in the vertical direction, as will be clarified using a modification example which will be described later.

The spindle 104 in the acceleration sensation presentation device 1 is movably supported by a spindle support unit. For example, according to the above described embodiment, a configuration including the arm unit 103 corresponds to the spindle support unit. As a matter of course, when there is a configuration in which the spindle 104 is movably supported, the configuration including the arm unit 103 is not limited.

The servo motors 120a and 120b are built into the housing (case) 101 of the acceleration sensation presentation device 1. The servo motor 120a corresponds to an example of a first spindle driving unit, and the servo motor 120b corresponds to an example of a second spindle driving unit. When the servo motor 120a is operated, the spindle 104 moves in the front-back direction. A mechanism which rotates by having the shaft 135 as the rotating shaft corresponds to an example of a first movable unit. When the servo motor 120b is operated, the spindle 104 moves in the horizontal direction which is approximately orthogonal to the front-back direction. A mechanism which rotates by having the shaft 130 as the rotating shaft corresponds to an example of a second movable unit. The arm unit 103 moves in conjunction with movements of the rotating mechanisms, and the spindle 104 which is attached to the end portion of the arm unit 103 moves. In addition, the spindle 104 may move in the vertical direction according to the operation of the servo motor 120a, for example.

It is possible to configure an acceleration sensation presentation system using a plurality of the acceleration sensation presentation devices. For example, according to the embodiment, the acceleration sensation presentation system is realized using two acceleration sensation presentation devices. As a matter of course, three or more acceleration sensation presentation devices may be used. The acceleration sensation presentation device 1 corresponds to a first acceleration sensation presentation device as an example, and the acceleration sensation presentation device 2 corresponds to a second acceleration sensation presentation device as an example.

The acceleration sensation presentation system includes at least two spindles. The acceleration sensation presentation system according to the embodiment includes the spindles 104 and 204. As described with reference to FIGS. 6 and 7, it is possible to move the spindles 104 and 204 in the same direction on the same axis approximately at the same time. As described with reference to FIG. 8, it is possible to move the spindles 104 and 204 in opposite directions on the same axis approximately at the same time. In addition, as described with reference to FIG. 9, it is possible to move only one spindle of the two spindles.

### 2. Modification Example

Hitherto, the embodiment of the present disclosure has been described in detail, however, the present disclosure is not limited to the above described embodiment, and can be subjected to various modifications based on technical ideas of the present disclosure.

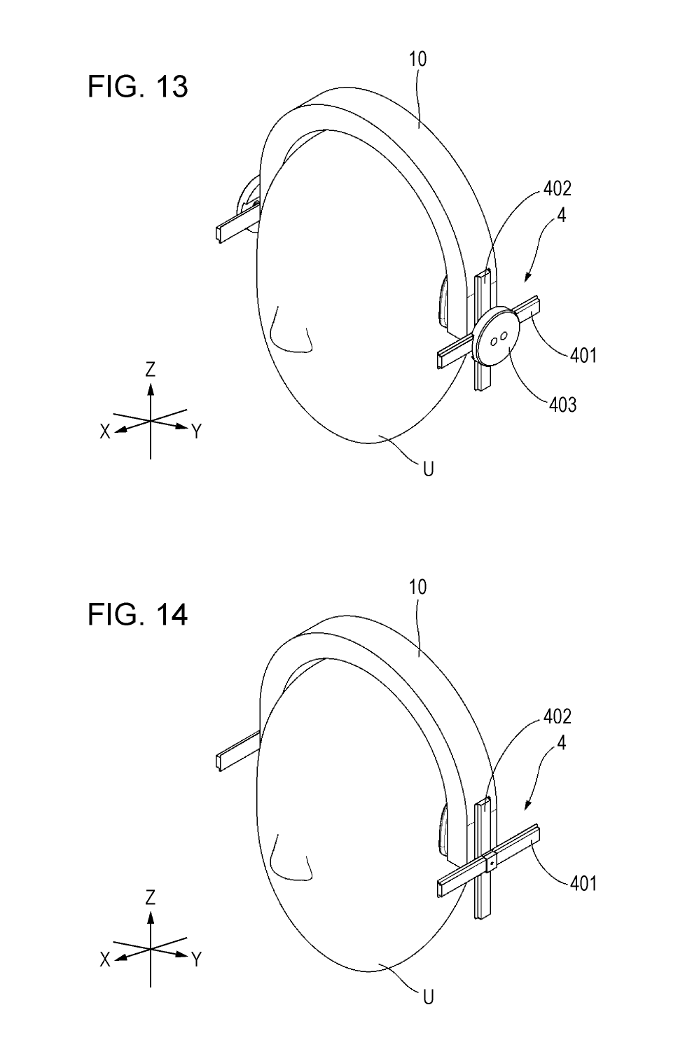

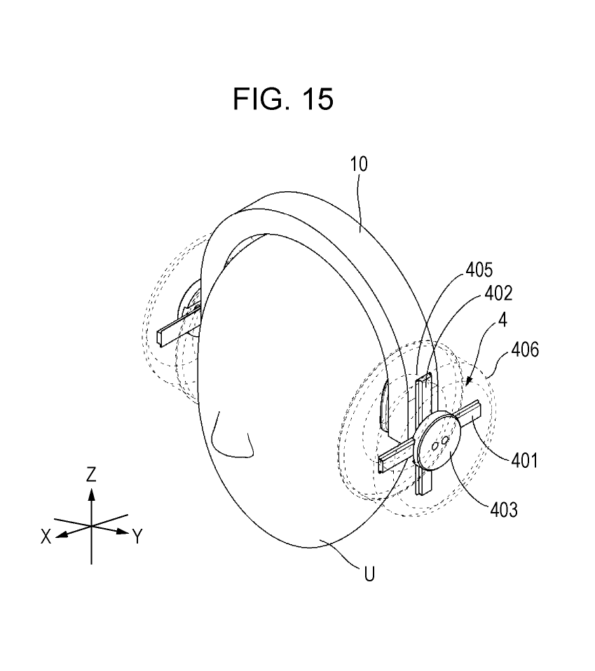

FIGS. 13 and 14 are diagrams which describe examples of configurations of acceleration sensation presentation devices according to modification examples. In the acceleration sensation presentation device 4 according to the modification example, as illustrated in FIG. 14, a rail unit 401 which extends in the X axis direction, and a rail unit 402 which extends in the Z axis direction are attached in the vicinity of the end portion of the head band 10. The rail units 401 and 402 intersect so as to form a cross. In the modification example, the X axis direction corresponds to a first direction as an example, and the rail unit 401 corresponds to a first rail unit as an example. In addition, the Z axis direction corresponds to a second direction as an example, and the rail unit 402 corresponds to a second rail unit as an example.

In addition, as illustrated in FIG. 13, a spindle 403 is supported as an initial position in the vicinity of an intersection of the rail units 401 and 402. The spindle 403 is configured so as to slide on the rail units 401 and 402. A spindle driving unit for moving the spindle 403, for example, a motor is built into the spindle 403 (or, may be outside thereof). A driving signal which is obtained based on acceleration information is supplied to the motor. The motor is operated when the driving signal is supplied, and the spindle 403 slides on the rail unit 401 or 402.

For example, when the spindle 403 moves to the lower side of the rail unit 402, it is possible to generate a reaction force which goes toward the upper side. In this manner, it is possible to present an acceleration sensation to the upper side to the user U. For example, when the spindle 403 is moved to the front of the rail unit 401, it is possible to generate a reaction force which goes backward. In this manner, it is possible to present an acceleration sensation to the rear side to the user U.

FIG. 15 is a diagram which illustrates an application example of the acceleration sensation presentation device in the modification example. As illustrated in FIG. 15, it is possible to accommodate a speaker 405 and an acceleration sensation presentation device 4 in an ear pad 406 of a headphone. In FIG. 15, an example of the ear pad 406 is denoted by a dotted line. The user U can use the acceleration sensation presentation device as if the device is a headphone. In addition, a rail unit of the acceleration sensation presentation device may be bent so as to go along the outer edge of a face of the user U. In this manner, it is possible to achieve space saving.

In addition, an acceleration sensation presentation device having the same configuration as that of the acceleration sensation presentation device 4 is also attached to the vicinity of one more end portion of the head band. In this manner, it is possible to change the configuration of the acceleration sensation presentation device.

In addition to this, various modifications are possible in the present disclosure. For example, the spindle may be returned to an initial position after being moved. At this time, it is possible to return the spindle to the initial position without giving a user a sense of incompatibility by moving the spindle at a low speed not generating a reaction force.

In the above described embodiment, two or more spindles may be provided in the acceleration sensation presentation device. For example, there may be a configuration in which a tip end of the arm unit is branched, and spindles are attached to a tip end of each branching path, respectively.

An acceleration sensation with different intensity may be presented by changing a movement distance of the spindle, or a movement speed of the spindle. In addition, the movement direction of the spindle is not limited to the front-back direction, the horizontal direction, and the vertical direction, and may be movement in the oblique direction.

A force generated along with a movement of the spindle is not limited to a reaction force. For example, the force may be a force which rotates the spindle. A torque is generated according to angular acceleration of the spindle when the spindle in rotated. A configuration may be used in which an acceleration sensation is presented to a user using an anti-torque which is generated in the direction opposite to the movement direction.

According to the above described embodiment, two acceleration sensation presentation devices are used, however, one acceleration sensation presentation device may be used. In this case, one acceleration sensation presentation device is attached to the vicinity of a top of the head of a user, for example.

The present disclosure can be realized using a method, a program, a system, or the like, without being limited to a device. A program can be provided to a user through a network, for example, or through a portable memory such as an optical disc, or a semiconductor memory.

In addition, it is possible to appropriately combine the configurations and processes in the embodiment and the modification example as long as technical contradiction does not occur. An order of each process in a flow of the exemplified process can be appropriately changed as long as technical contradiction does not occur.

The present disclosure also can be configured as follows.

(1) An acceleration sensation presentation device which is attached to a vicinity of head of a user, the device including one or a plurality of spindles; and a spindle driving unit which generates a force in a direction different from a predetermined direction by moving the spindle in the predetermined direction.
(2) The acceleration sensation presentation device which is described in (1), which includes a spindle support unit which movably supports the spindle.
(3) The acceleration sensation presentation device which is described in (1) or (2), in which the spindle driving unit moves the spindle in at least one of a front-back direction, a horizontal direction, and a vertical direction with respect to the user.
(4) The acceleration sensation presentation device which is described in any one of (1) to (3), in which a driving signal which is obtained based on predetermined acceleration information is supplied to the spindle driving unit, and the spindle driving unit moves the spindle according to the supplied driving signal.
(5) The acceleration sensation presentation device which is described in any one of (1) to (4), in which the spindle driving unit is configured of a servo motor.
(6) An acceleration sensation presentation device which is attached to the vicinity of the head of the user, the device including:

a housing into which a first spindle driving unit and a second spindle driving unit are built;

a first movable unit which moves in a first direction according to an operation of the first spindle driving unit;

a second movable unit which moves in a second direction which is approximately orthogonal to the first direction according to an operation of the second spindle driving unit;

an arm unit which moves in the first direction in conjunction with the operation of the first movable unit, or moves in the second direction in conjunction with the operation of the second movable unit; and

a spindle which is attached to an end portion of the arm unit.

(7) An acceleration sensation presentation device which is attached to a vicinity of head of a user, the device including:

a spindle;

a first rail unit for causing the spindle to slide in a first direction according to a control by a spindle driving unit; and

a second rail unit for causing the spindle to slide in a second direction which is orthogonal to the first direction according to a control by the spindle driving unit.

(8) An acceleration sensation presentation method which includes:

movably supporting a spindle using a spindle support unit in a vicinity of head of a user; and

generating a force in a direction different from a predetermined direction by moving the spindle in the predetermined direction according to a control by a spindle driving unit.

(9) An acceleration sensation presentation system which includes:

a first acceleration sensation presentation device which is attached to a vicinity of one ear of a user, and

a second acceleration sensation presentation device which is attached to a vicinity of the other ear of the user,

in which the first acceleration sensation presentation device includes

a first spindle;

a first spindle support unit which movably supports the first spindle; and

a first spindle driving unit which generates a force in a direction different from a predetermined direction by moving the first spindle in the predetermined direction,

in which the second acceleration sensation presentation device includes

a second spindle;

a second spindle support unit which movably supports the second spindle; and

a second spindle driving unit which generates a force in a direction different from the predetermined direction by moving the second spindle in the predetermined direction,

in which the first spindle driving unit moves the first spindle in at least one of a front-back direction, a horizontal direction, and a vertical direction with respect to the user, and

in which the second spindle driving unit moves the second spindle in at least one of the front-back direction, the horizontal direction, and the vertical direction with respect to the user.

(10) The acceleration sensation presentation system which is described in (9), in which the first and second spindle driving units move the first and second spindles in the same direction, respectively, at approximately the same time.
(11) The acceleration sensation presentation system which is described in (9) or (10), in which the first and second spindle driving units move the first and second spindles in opposite directions, respectively, at approximately the same time.

It should be understood by those skilled in the art that various modifications, combinations, sub-combinations and alterations may occur depending on design requirements and other factors insofar as they are within the scope of the appended claims or the equivalents thereof.

What is claimed is:

1. An acceleration sensation presentation device which is attached to a vicinity of head of a user, the device comprising:
one or a plurality of spindles; and
a spindle driving unit which generates a force in a direction different from a predetermined direction by moving the spindle in the predetermined direction.

2. The acceleration sensation presentation device according to claim 1, further comprising:
a spindle support unit which movably supports the spindle.

3. The acceleration sensation presentation device according to claim 1,
wherein the spindle driving unit moves the spindle in at least one of a front-back direction, a horizontal direction, and a vertical direction with respect to the user.

4. The acceleration sensation presentation device according to claim 1,
wherein a driving signal which is obtained based on predetermined acceleration information is supplied to the spindle driving unit, and the spindle driving unit moves the spindle according to the supplied driving signal.

5. The acceleration sensation presentation device according to claim 1,
wherein the spindle driving unit is configured of a servo motor.

6. An acceleration sensation presentation device which is attached to the vicinity of the head of the user, the device comprising:
a housing into which a first spindle driving unit and a second spindle driving unit are built;
a first movable unit which moves in a first direction according to an operation of the first spindle driving unit;
a second movable unit which moves in a second direction which is approximately orthogonal to the first direction according to an operation of the second spindle driving unit;
an arm unit which moves in the first direction in conjunction with the operation of the first movable unit, or moves in the second direction in conjunction with the operation of the second movable unit; and
a spindle which is attached to an end portion of the arm unit.

7. An acceleration sensation presentation device which is attached to a vicinity of head of a user, the device comprising:
a spindle;
a first rail unit for causing the spindle to slide in a first direction according to a control by a spindle driving unit; and
a second rail unit for causing the spindle to slide in a second direction which is orthogonal to the first direction according to a control by the spindle driving unit.

8. An acceleration sensation presentation method comprising:
movably supporting a spindle using a spindle support unit in a vicinity of head of a user; and
generating a force in a direction different from a predetermined direction by moving the spindle in the predetermined direction according to a control by a spindle driving unit.

9. An acceleration sensation presentation system comprising:
a first acceleration sensation presentation device which is attached to a vicinity of one ear of a user; and
a second acceleration sensation presentation device which is attached to a vicinity of the other ear of the user,
wherein the first acceleration sensation presentation device includes
a first spindle;
a first spindle support unit which movably supports the first spindle; and
a first spindle driving unit which generates a force in a direction different from a predetermined direction by moving the first spindle in the predetermined direction,
wherein the second acceleration sensation presentation device includes
a second spindle;
a second spindle support unit which movably supports the second spindle; and
a second spindle driving unit which generates a force in a direction different from the predetermined direction by moving the second spindle in the predetermined direction,
wherein the first spindle driving unit moves the first spindle in at least one of a front-back direction, a horizontal direction, and a vertical direction with respect to the user, and
wherein the second spindle driving unit moves the second spindle in at least one of the front-back direction, the horizontal direction, and the vertical direction with respect to the user.

10. The acceleration sensation presentation system according to claim 9,
wherein the first and second spindle driving units move the first and second spindles in the same direction, respectively, at approximately the same time.

11. The acceleration sensation presentation system according to claim 9,
wherein the first and second spindle driving units move the first and second spindles in opposite directions, respectively, at approximately the same time.
